(19) United States
(12) Patent Application Publication
(10) Pub. No.: US 2008/0010082 A1
(43) Pub. Date: Jan. 10, 2008

(54) System and method for business process management

(75) Inventors: Zhong Bo Jiang, Beijing (CN); Jian Bo Li, Beijing (CN); Shixia Liu, Beijing (CN); Tiejun Ou, Beijing (CN); Wei Sun, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/823,011

(22) Filed: Jun. 26, 2007

(30) Foreign Application Priority Data
Jun. 27, 2006 (CN) 200610094154.7

(51) Int. Cl. G06Q 50/00

(52) U.S. Cl. 705/1

(57) ABSTRACT

A method for monitoring a business process, comprising modeling the business process to obtain a business process model including IT activities and non-IT activities; auto-defining an activity state dependency table for the non-IT activities; monitoring states of said IT activities; and monitoring, by referring to said activity state dependency table, states of said non-IT activities. By implementing the present invention, all the activities (including IT and non-IT activities) in the business process can be monitored, so that it is convenient for a user to know a status of the overall business process. In addition, the present invention utilizes visual text, icon, video and audio to display the activities and their states, which is helpful for the user to monitor and understand the status of the business process.

### FIELD OF TECHNOLOGY

The present invention relates in general to the field of information technology, and specifically to a system and method for business process monitoring.

### BACKGROUND OF THE INVENTION

In the field of information technology, business process integration and management (including business process monitoring) is emerging as a set of key technologies to improve operational efficiency.

However, current business process monitoring functions are mainly for administration purposes and there is no special consideration for displaying the process execution status in an easy-to-understand way for a business user/operator. Thus, it is impossible to really realize a complete and direct business process monitoring. This is mainly reflected in the following aspects.

First, a business process itself contains not only activities being executed by a workflow engine or other IT systems (called IT activities), but also manual activities which are integral parts of the process and supplemental activities which facilitate people's understanding (called non-IT activities). However, the current business process monitoring functions can only monitor the IT activities (the states of the IT activities are monitored by events in a computer), and lacking an effective way to monitor these non-IT activities, they are usually excluded from the current process tracking function. When these non-IT activities have to be monitored, the current way is to convert these non-IT activities into IT activities and then monitor the IT activities. For example, a manager signs a paper document and then accesses the computer system and monitors the non-IT activity by changing the execution status of the process stored in the computer via specific operations.

The IT activities and non-IT activities are illustrated below with reference to FIG. 1A and FIG. 1B.

FIG. 1A shows three activities included in a business process: Generate Payment Bill A, Approve by Manager B, and Notify Supplier C. Among these three activities, activities A and C are IT activities, while the activity “Approve by Manager B” marked with a dashed circle is a manual activity. As for the current business monitoring functions, activities A and C can be monitored, while activity B cannot be monitored. However, from a business process prospective, activity B is also an integral part of the whole business process and its existence in the overall business process monitoring helps people better understand the business process and monitor it in a clearer way.

FIG. 1B shows three activities included in another business process: Auto-check Order X, Buyer Check Order Y, and Effective Order Z. Among these three activities, activities X and Y are IT activities, while the activity “Effective Order Z” marked with a dashed circle is not a real activity for the business process. As for the current business monitoring functions, activities X and Y can be monitored, while activity Z cannot be monitored. However, activity Z, as an additional piece of information, makes the business process easier to be tracked and consumed by a business user.

It can be seen that, the existing business process monitoring functions cannot realize an integrated business process monitoring.

Second, the current business process monitoring functions do not possess the ability to define timeout, triggering. (such as notifying) and so on for all the activities (including the activities executed in the computer system and those not directly executed in the computer system).

Third, an interface of the current business process monitoring functions is generally technical, without providing the technology for expressing and describing a single business process in a direct and clear way, so that without the special knowledge on the process monitoring, it is hard to understand the states of respective activities in the process.

Therefore, it is desirable to provide a system and method capable of facilitating business process monitoring by participants of a business process.

### SUMMARY OF THE INVENTION

In view of the above problems of the prior art, a system and method of the present invention are set forth.

According to one aspect of the present invention, a method for monitoring a business process is provided, the method comprising: modeling a business process to obtain a business process model which includes IT activities and non-IT activities; auto-defining an activity state dependency table for the non-IT activities; monitoring states of said IT activities; and monitoring states of said non-IT activities by referring to said activity state dependency table.

According to a further aspect of the present invention, a system for monitoring an overall business process is provided, the system comprising: a process skeleton designer for modeling a business process to obtain a process model which includes IT activities and non-IT activities, wherein states of said IT activities are monitored with outer events; a process designer for auto-defining an activity state dependency table for the non-IT activities; and an activity dependency manager for, by referring to said activity state dependency table, monitoring states of said non-IT activities.

The present invention can be employed to monitor all the activities of the business process, including IT activities and non-IT activities, so that the activities (such as manual activities and additional status activities, etc.) in the computer system state information of which cannot be directly obtained can be integrally expressed and monitored.

A preferred embodiment of the present invention provides the steps of monitoring states of said non-IT activities, comprising: receiving events related to state change of IT activities and/or non-IT activities and extracting the states of said IT activities and/or non-IT activities; inspecting an activity dependency table to determine whether or not the state change of said IT activities and/or non-IT activities will trigger state changes of other non-IT activities; if it is determined that the state change of said IT -activities and/or non-IT activities will trigger the state changes of said other non-IT activities, transmitting events that trigger the state changes of said other non-IT activities.

The preferred embodiment of the present invention further provides the step of monitoring the states of said non-IT activities in a recursive way, that is, further determining, in the foregoing step of determining whether or not the state change of said IT activities and/or non-IT activities will trigger state changes of other non-IT activities, whether or not the state change of said IT activities and/or non-IT activities is the only dependency that will trigger state changes of other non-IT activities; if yes, executing the step of transmitting events which trigger the state changes of said other non-IT activities; otherwise, perform the operations recursively until all the dependencies are satisfied, and then executing the step of transmitting events which trigger the state changes of said other non-IT activities.

Further, according to the preferred embodiment of the present invention, visual characters, icons, pictures, videos or sound are used to expressly demonstrate activities of the business process and state of the activities so as to facilitate the business process monitoring. The present invention, for process participants, provides special designing steps (and modules) to support the design showing the business process, and the designing result can be directly mapped to a monitoring interface during operation.

Further, according to the preferred embodiment of the present invention, by setting a timer, it is possible to provide various abilities including defining timeout, act triggering (such as notifying) and the like for all the activities (including the activities executed in the computer system and those not directly executed in the computer system), and to make an expansion as specifically required, so that the process monitoring modes become diversified and the monitoring ability is strengthened.

### BRIEF DESCRIPTION OF THE ACCOMPANYING DRAWINGS

FIG. 1A and FIG. 1B show IT-activities and non-IT activities.

FIG. 2 is a block diagram showing a typical system for monitoring a business process.

FIG. 3 is a block diagram showing a basic structure of a system according to the present invention.

FIG. 4A shows states of the IT-activities and non-IT activities shown in FIGS. 1A and 1B; and FIG. 4B shows a state dependency table of the non-IT activities and IT-activities shown in FIGS. 1A and 1B.

FIG. 5A shows a business process for approving a document, and FIG. 5B shows an activity state dependency table of the business process.

FIG. 6 is a flowchart showing a method according to the present invention.

FIG. 7 is a flowchart showing a method of monitoring states of non-IT activities according to one embodiment in the present invention.

FIG. 8 is a flowchart showing a method of monitoring states of non-IT activities according to one embodiment in the present invention.

FIG. 9 is a block diagram of a system showing a business process according to the present invention.

FIG. 10 is a block diagram showing improvements on the basic structure in FIG. 3 on the basis of the system shown in FIG. 9.

### DETAILED DESCRIPTION OF THE INVENTION

The preferred embodiment is explained below with reference to the drawings.

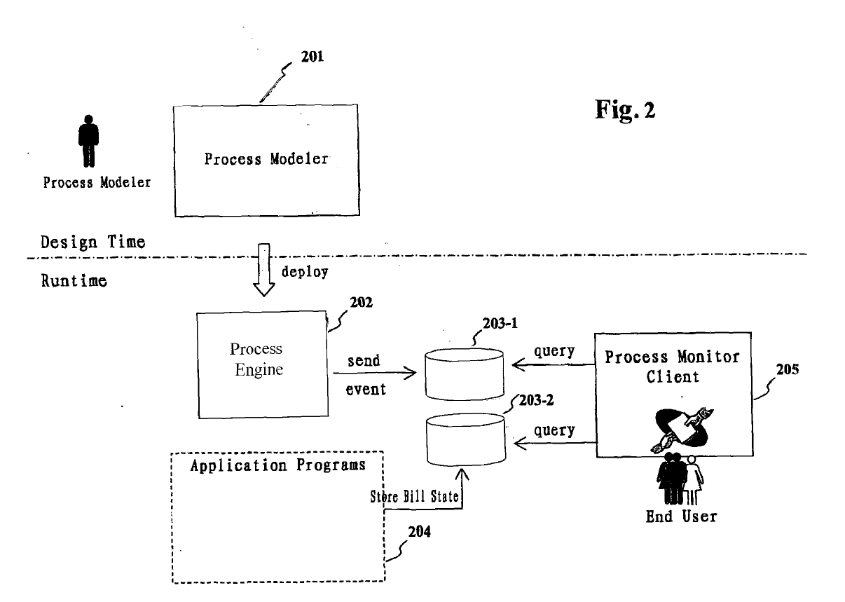

First, FIG. 2 is a block diagram showing a typical system for monitoring a business process. The system shown in FIG. 2 is divided into two sections: a Design Time section and a Runtime section.

During design time, the system comprises a process modeler 201 for modeling a business process by business modeling personnel to obtain a logical business process model.

During runtime, the system comprises a process engine 202, separate repositories 203-1 and 203-2, applications 204 and a process monitor client 205, wherein the process engine 202 is responsible for executing those executable processes and sending, after the execution of the processes, corresponding events to the repository 203-1 for storage, and the applications 204 are for executing some activities in the processes and sending, subsequent to the execution, states of documents within a process to the repository 203-2 for storage. An end user may query the repositories 203-1 and 203-2 about a current execution situation of the business process via a process monitor client 205.

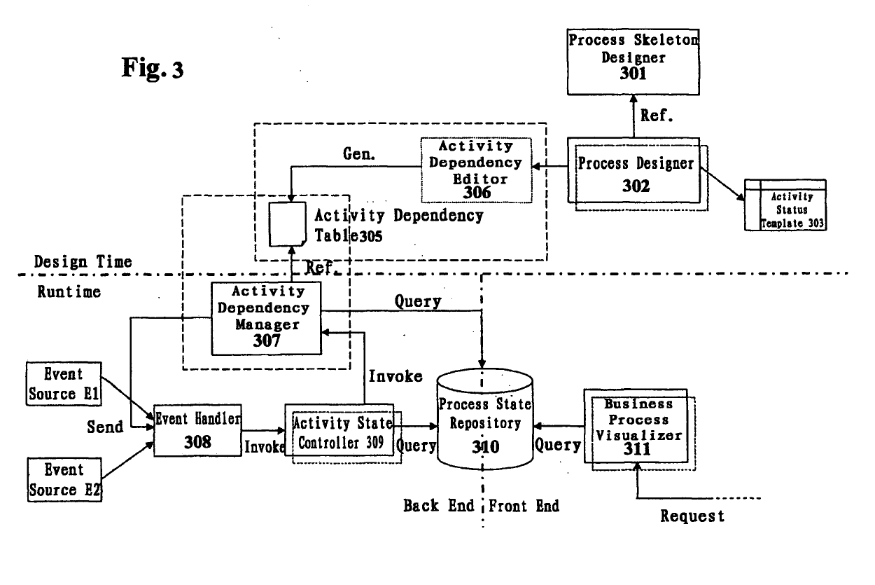

As stated-above, the typical system in FIG. 2 can only be used for monitoring IT-activities and is incapable of monitoring non-IT activities. Thus, a basic structure of an improved system according to the present invention as shown in FIG. 3 is set forth, so as to simultaneously monitor the IT activities and non-IT activities.

As shown in FIG. 3, the system according to the present invention can be similarly divided into a Design Time section and a Runtime section. During design time, the system mainly comprises a process skeleton designer 301, a process designer 302, an activity status template 303 and an activity state dependency table 305. During runtime, the system is further divided into a back end and a front end, wherein the back end includes an activity state dependency manager 307, an event handler 308, an activity state controller 309, and the front end includes a business process visualizer 311. A process state repository 310 is a component which can be utilized during both the front end and back end operations.

The process skeleton designer 301 is a component for modeling a business process and for depicting and obtaining a logical business process model. According to the present invention, said logical business process comprises both IT-activities and non-IT activities. It should be understood that only from the modeling perspective, there is no substantive difference between the non-IT activities and the IT-activities and they can be handled in the same way. Said process skeleton designer 301 can be realized by using any commercially available process modeler, such as UML, Visio and the like.

The activity state template 303 is for storing one or more sets of pre-defined activity states, such as Finished, Disabled, Ready, Abnormal, Terminated, etc.

The process designer 302 is for generating an activity state dependency table 305 for non-IT activities in the logical business process model established by the process skeleton designer 301 by referring to the activity status template 303.

Furthermore, in the preferred embodiment according to the present invention, considering that activity states of particular activities may be different from pre-defined states in the activity status template 303, the system further provides an activity state dependency editor 306, so that the user can add or delete one or more states based on the template to generate self-defined activity states, thereby improving the activity state dependency table 305 which is auto-defined by the process designer 301, or completely manually creating the activity state dependency table 305.

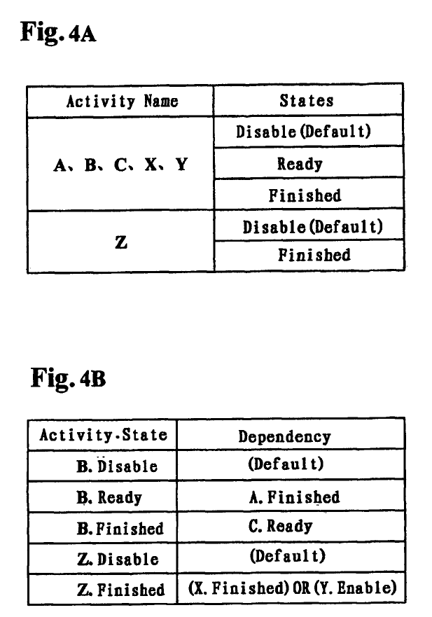

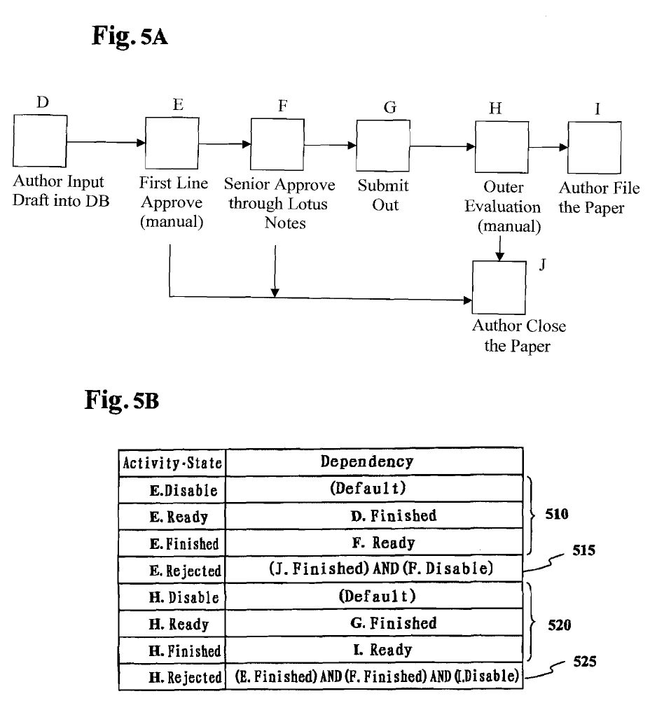

The activity state dependency table 305 is explained below with reference to FIG. 4A, FIG. 4B, FIG. 5A and FIG. 5B.

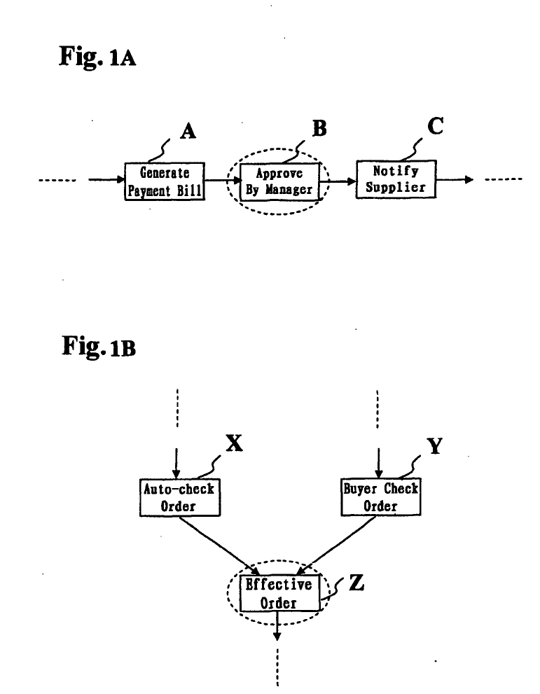

FIG. 4A is an exemplary table showing activities and their possible states with reference to the cases in FIG. 1A and FIG. 1B. As shown in FIG. 4A, each of the activities A, B, C, X and Y can have three states: Disabled. Ready and Finished, while activity Z only has two states: Disabled and Finished. As shown in FIG. 4A, the present invention exemplarily assumes the Disabled state is a default state, but those skilled in the art understand whichever state serves as the default state is irrelevant to the implementation of the present invention.

FIG. 4B is an exemplary activity state dependency table for two non-IT activities B and Z shown in FIG. 4A. As shown in FIG. 4B, the state of non-IT activity B in a default case is “Disabled”; in the case where the state of IT activity A is “Finished”, the state of B is changed to “Ready”; in the case where the state of IT activity C is “Ready”, the state of B is changed to “Finished”. The state of non-IT activity Z in a default case is “Disabled”; in the case where the state of IT activity X is “Finished” or the state of IT activity Y is “Finished”, the state of Z is changed to “Finished”. According to FIG. 4B, the state of one non-IT activity may either merely depend on the state of one other activity (such as the case of the non-IT activity B), or depend on states of more than one of other activities (such as the case of the non-IT activity Z). As for the latter, it is possible to utilize for example logical operators to define dependency of the non-IT activity on said more than one of other activities.

It should be understood that, states of activities which some business processes include are relatively fixed (for example, only including three states: “Finished”, “Disabled”, and “Ready”), and a state dependency pattern between non-IT activities and IT activities is relatively fixed as well. In this case, the state dependency of the non-IT activities can be auto-defined by the process designer. For instance, as for the linear business process as shown in FIG. 1A, its activity state dependency may always abide by the state dependency associated with activity B as listed in FIG. 4B. Taking another example, as for the “Y-shaped” business process as shown in FIG. 1B, its activity state dependency may always abide by the state dependency associated with activity Z as listed in FIG. 4B.

FIG. 5A shows a relatively complicated document approving business process. By modeling the document approving business process, the respective activities as shown in FIG. 5A are obtained, in which activities D, F, G, I, and J represented by the shadowed blocks are IT activities, while activities E and H represented by non-shadowed blocks are non-IT activities.

FIG. 5B shows a state dependency table 305 defined for the above business process. From the state dependency table,, it can be seen that the state dependency table not only includes state dependency entries 510, 512 defined for the linear business process, but also includes state dependency entries 515, 525 specific to the above business process. As for the state dependency shown in FIG. 5B, the user may input, via the state dependency editor 306, dependencies associated with activities E and H in a “Rejected” state. In addition, FIG. 5B further shows the state change of a non-IT activity can depend not only on the state change of an IT activity, but also on the state change of another non-IT activity.

It should be understood that the simple state dependencies shown in FIG. 4A, FIG. 4B, FIG. 5A and FIG. 5B are only for the sake of explanation but should not be construed as any limitation on the present invention.

Continuing to refer to FIG. 3, during, runtime of the system, the event handler 308 is configured to receive events associated with state changes of IT activities from the external and/or receive events associated with state changes of non-IT activities from the activity dependency manager 307, and extracts therefrom the states of said IT activities or non-IT activities and sends the extracted activity states to the activity state controller 309.

The activity state controller 309 stores the states into a process state repository 310 to update states associated with said IT activities or non-IT activities stored in the process state repository on one hand, and invokes the activity state dependency manager 307 to determine whether the states of said non-IT activities or non-IT activities trigger state changes of other non-IT activities on the other hand.

Upon receiving the invocation from the activity state controller 309, the activity state dependency manager 307 consults the activity state dependency table 305 so as to determine whether or not the state changes of other non-IT activities will take place. When the state changes of other non-IT activities will indeed take place, the activity state dependency manager 307 will send this situation to the event handler 308.

The process state repository 310 is configured to store states of activities in the business process. As aforesaid with reference to FIG. 2, in the prior-art business process monitoring, the process engine and the application programs are separated and they need to utilize different repositories to store events in the process or document state data. However, according to the present invention, the system utilizes a unified process state repository 310 to store states of the activities in the business process so as to realize the process monitoring.

At the front end of the system, when an end user requests to check a business process, the end user inputs information of the business process to be queried (such as an ID of the business process) via a computer (for example, it may be a text input box on a user interface). Thus, the computer queries the process state repository 310 to acquire states of the activities in the business process and present them to a user via a business process renderer or business process visualizer 311 (for example, in any known way of the prior art or in the below-described way provided by the present invention).

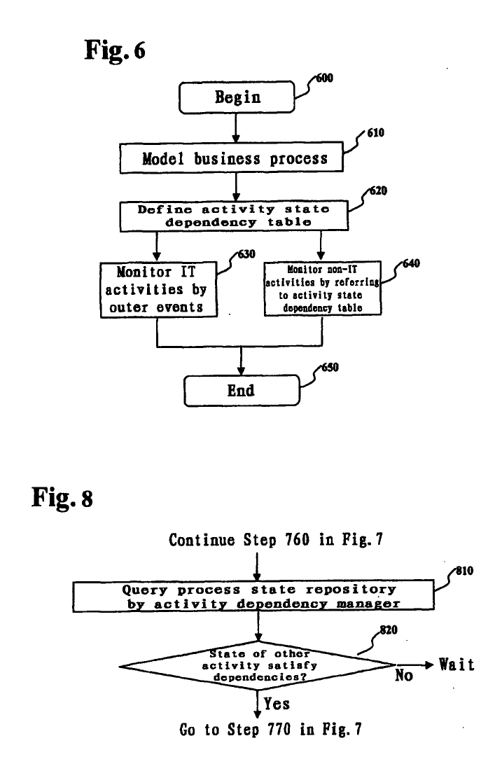

FIG. 6 shows a method according to the present invention. This method begins with Step 600 and then goes to Step 610. In Step 610, the method of the present invention models the business process to describe a logical business process model, said model including IT activities and non-IT activities. Next, in Step 620, an activity state dependency table is auto-defined for the non-IT activities. Subsequently, in Step 630, state changes of the IT activities are monitored by means of external events, and in Step 640, state changes of said non-IT activities are monitored by referring to said activity state dependency table. The method according to the present invention ends in Step 650. By using the method according to the present invention as described in FIG. 6, the business process can be integrally monitored and expressed.

As described above, Step 610 of modeling the business process can be implemented using any modeling mode known in the art, which is not described in detail here.

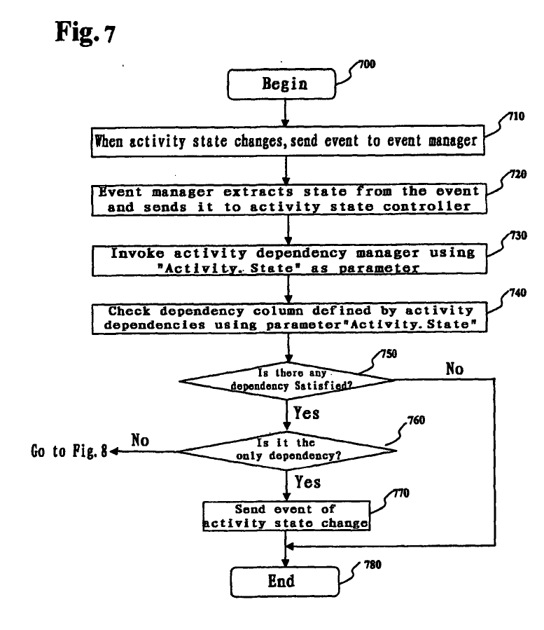

Taking the business process shown in FIG. 5A as an example, the process in which the activity state dependency manager 307 determines the state of non-IT activity H by using the state dependency table 305 is described below in detail with reference to FIG. 7 and FIG. 8.

The process shown in FIG. 7 begins with Step 700 and then goes to Step 710.

In Step 710, when a state change of an activity in the business process takes place, the corresponding event is sent to the event manager 308. Here, assume that an event indicating activity G is finished is sent to the event manager.

Next, in Step 720, the event manager 308 extracts the state (i.e., G. Finished) from the event and sends it to the activity state controller 309.

Then, in Step 730, the activity state controller 309 updates the state of activity G of a current author in the process state repository 310 by using the received activity state on one hand, and on the other hand, invokes the activity dependency manager 307 using for example “Activity. State” (i.e., G. Finished) as a parameter.

Subsequently, in Step 740, the activity dependency manager 307 checks a “dependency” column in the activity state dependency table 305 using the parameter “G. Finished”.

In Step 750, the activity dependency manager 307 determines whether there is any dependency being satisfied. If no dependency is satisfied (“No” branch), the method turns to Step 780 to stop operation. If it is determined in Step 750 that there is a dependency being satisfied (“Yes” branch), whether or not the dependency is the only one is further determined in Step 760.

If the determination result in Step 760 is “Yes” (that is,. “G. Finished” is the unique dependency), an event indicating an activity state change is sent to the event handler 308 in Step 770 (that is, the state of activity “B” is changed to “Ready”). Finally, the method ends in Step 780.

The method shown in FIG. 7 involves the case in which the state change of one non-IT activity merely depends on the state change of one other activity. However, as shown in FIG. 5B, if the state of non-IT activity H is to be changed to “Rejected”, it needs to depend on state changes of plural other activities (i.e., the case in which the determination result of Step 760 is “No” as shown in FIG. 7). The operations in this case are further described below with reference to FIG. 7 and FIG. 8.

At this time, the operations still begin with Step 700 and then go to Step 710, assuming an event indicating activity F is finished is sent to the event manager 308. Next, Steps 720-760 shown in FIG. 7 are performed, and the determination result of Step 760 is “No”. Thus, the operations turn to Step 810 shown in FIG. 8.

In Step 810, the activity dependency manager 307 queries the process state repository 310 about states of other activities which said non-IT activity depends on (e.g., the states of activities E and I). Then, in Step 820, whether or not the states of activities E and I can satisfy the dependencies is determined. If the determination result of Step 820 is “Yes” (for example, the state of E is “Finished” and the state of I is “Disabled”), the method returns to Step 770 shown in FIG. 7 to send an event indicating a state change of non-IT activity H takes place. Otherwise, the activity dependency manager 307 does not change the state of non-IT activity H and continues to wait, until the states of all the activities on which the non-IT activity depends can satisfy the state dependencies.

According to the present invention, if a state change of a non-IT activity does not merely depend on a state of one other activity, only when satisfying all the dependencies defined in the activity state dependency table, can the state change of the non-IT activity take place. When all the dependencies which cause the state change of the non-IT activity to take place are not satisfied, the system performs a recursive processing, until all the dependencies which cause the state change of the non-IT activity to take place are satisfied.

Furthermore, in a preferred embodiment according to the present invention, timeout and triggered action can be defined for non-IT activities. For example, in FIG. 5A, suppose the timeout for “Outer Evaluation” H is set to 30 days and the triggered action is to send an email. Then 30 days after the state of “Outer Evaluation” is changed to “Ready”, the system will automatically reminds (for example, by sending an email) the author of the following steps. Those skilled in the art understand that it is possible to set a timer in the system or utilize other ways to provide various abilities including defining timeout and triggered action (such as notifying) for all the activities (including activities executed in the computer system and those not directly executed in the computer system), and also possible to have an expansion as specifically required, so that the manner of process monitoring becomes diversified and the monitoring ability is enhanced. So-called “expansion” is an action which can be triggered when the activity state is changed. From the perspective of implementation, the expansion is linked with the process monitoring via a state transition event, that is to say, specific states of activities in the process can be associated with the corresponding events, and when a state is achieved, an event is triggered. The specifically triggered action, i.e., the expansion concerned here, is decided as required, and it can be sending a message notification, or invoking a complicated processing program.

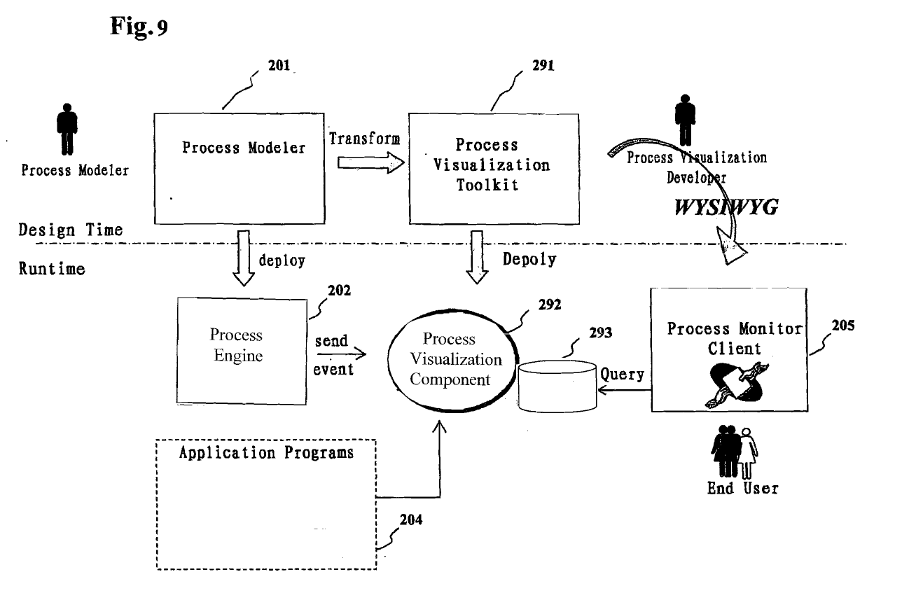

In addition, as described above, in the existing business process monitoring functions, the business process monitoring interface is usually technical rather than friendly to a user. Thus, it is hard for the non-technical users to dearly know what the activities in the business process or their states are like. Therefore, the invention of the present invention further provides a support module capable of describing and expressing the activities of the business process and their states in a directly clear way, as shown in FIG. 9.

In FIG. 9, a process visualization toolkit 291 and a process visualization component 292 are added on the basis of FIG. 2, and the originally separated repositories 203-1 and 203-2 are replaced with a single process state repository 293. The process visualization toolkit 291 is configured to associate execution statuses of the process with multimedia elements to complete the design of process visualization. The process visualization component 292 receives status information of event execution of process activity state changes sent from the process engine 202 and the application programs 204, and stores them into the process state repository 293. The process state repository 293 here corresponds to the process state repository 310 shown in FIG. 3.

Furthermore, as those skilled in the art know, although FIG. 9 shows the process engine 202 and the process visualization component 292 work independently of each other, they can also run in the same environment (for example, on one middleware platform).

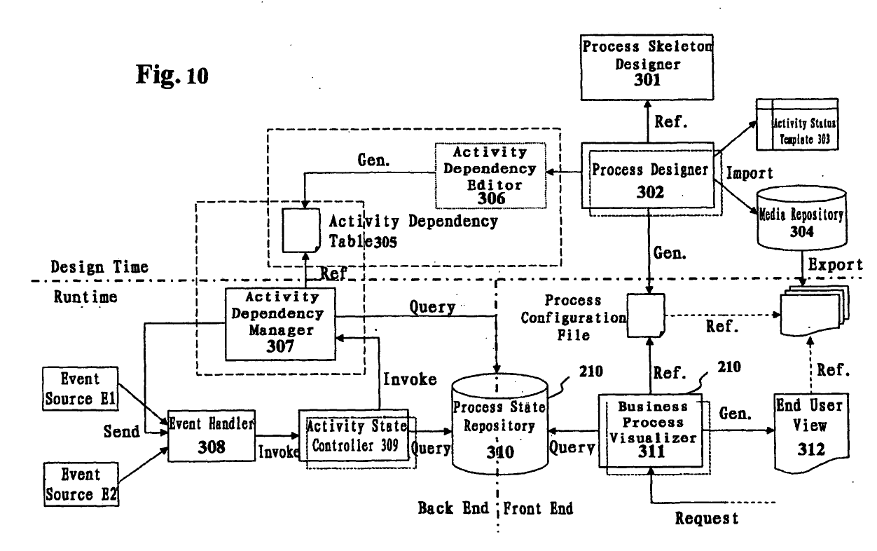

Corresponding to the system shown in FIG. 9, the basic structure diagram of FIG. 3 is modified as shown in FIG. 10. In FIG. 10, the same components as those in FIG. 3 are not described, but only those newly-added components are described below.

In FIG. 10, a media repository 304 is for storing various media files, such as text, image, video, animation, and audio, etc.

In order to visualize the business process, the process designer 302, while generating the activity state dependency table 305, can further associate the activities and their states in the table 305 with one or more media files (including but not limited to text, icon, picture, video and audio, etc.) in the media repository 304 by referring to the media repository 304. For example, as for “Notify Supplier” activity C shown in FIG. 1A, this activity can be represented by an icon capable of visually and vividly showing its meaning (such as an icon showing a person is calling), and different colors or pictures, showing different facial expressions of the person who is calling are utilized to respectively represent its states: Disabled, Ready and Finished. In addition, as those skilled in the art understand, the activities and their states can be further associated with special audio files, so that it is convenient for the visually-impaired users to monitor the business process.

In the process in which the process designer 302 associates the activities in the business process and their states with one or more media files, the process designer 302 can further generate a process configuration file. This file lists the activities in the business process, states of the activities and media files utilized for the activities and states.

When a user queries the system about the business process, the system will query the process state repository 310 about the current activity states. After acquiring the activity states, the system will refer to said process configuration file 312 and dynamically invoke one or more media files 314 to render an end user view 312 on the business process visualizer 311 in the form of video, image, text and the like, or to play the query result to the user in an audio form.

In addition, those skilled in the art will realize that the embodiments of the present invention can be provided in the form of method, system or a computer program product. Thus, the present invention can adopt the form of full-hardware embodiments, full-software embodiments or embodiments of the combination of hardware and software. The typical combination of hardware and software can be a universal computer system with a computer program, and when the program is loaded or executed, the above method can be performed by controlling the computer system.

The present invention can be embedded into a computer program product, which comprises all the features which enable the described method to be implemented. Said computer program product is contained in one or more computer readable storage media (comprising but not limited to a disk storage, a CD-ROM, an optical memory and the like), and said computer readable storage media have computer readable codes contained therein.

The present invention is explained above with reference to the flow charts and/or block diagrams of the method, system and computer program product according to the present invention. Each block in the flow charts and/or block diagrams and the combination of the blocks therein can be obviously realized by computer program commands. These computer program commands can be supplied to a processor of a universal computer, a dedicated computer, an embedded processor or other programmable data processing devices to produce a machine, so that the commands (through the processor of a computer or other programmable data processing devices) produce an apparatus for realizing the functions specified in one or more blocks in the flow charts and/or block diagrams.

These computer program commands can also be stored to read memories of one or more computers, and each of the read memories can direct the computer or other programmable data processing devices to function according to a specified mode. Thus, the commands stored in the computer read memories produce a manufacturing product which comprises commanding means for realizing the functions specified in one or more blocks in the flow charts and/or block diagrams.

The computer program commands can also be loaded to one or more computers or other programmable data processing devices so as to perform a series of operating steps on said computers or other programmable data processing devices, so that a computer-implemented process can be produced on each of these devices. Thus, the commands executed on these devices provide the steps specified in one or more blocks in the flow charts and/or block diagrams.

Referring to the preferred modes for carrying out the present invention, the principles of the present invention are explained above. However, these explanations are only exemplary and should not be understood as any limitation to the present invention. Those skilled in the art can modify and transform the present invention, without departing from the spirit and scope defined by the appended claims.

What is claimed is:

1. A method for monitoring a business process, comprising the steps of:
modeling the business process to obtain a business process model, said model including information technology (IT) activities and non-IT activities;
auto-defining an activity state dependency table for the non-IT activities;
monitoring states of said IT activities; and
monitoring, by referring to said activity state dependency table, states of said non-IT activities.

2. The method according to claim 1, wherein the step of auto-defining said activity state dependency table is executed by referring to an activity status template.

3. The method according to claim 1, wherein the step of monitoring the states of said non-IT activities comprises the steps of:
receiving events associated with state changes of at least one of said IT activities and non-IT activities, and extracting the states of said at least one of the IT activities and non-IT activities;
checking the activity state dependency table to determine whether the state changes of said at least one of the IT activities and non-IT activities will trigger activity changes of other non-IT activities; and
sending, if it is determined that the state changes of said at least one of the IT activities and non-IT activities will trigger the state changes of other non-IT activities, events which trigger the state changes of said other non-IT activities.

4. The method according to claim 3, where the step of determining whether the state changes of said at least one of the IT activities and non-IT activities will trigger activity changes of other non-IT activities further comprises:
determining whether the state changes of said at least one of the IT activities and non-IT activities are the only dependency that triggers the state changes of other non-IT activities;
executing, if yes, the step of sending the events which trigger the state changes of said other non-IT activities; and
otherwise, recursively executing operations, and until all the dependencies are satisfied, executing the step of sending the events which trigger the state changes of said other non-IT activities.

5. The method according to claim 1, further comprising rendering a result of monitoring the business process to a user.

6. The method according to claim 5, wherein the step of rendering a result of monitoring the business process to a user can be executed in at least one of text, icon, picture, video and audio.

7. The method according to claim 1, further comprising defining timeout and triggered action for the non-IT activities.

8. A system for monitoring a business process, comprising:
a process skeleton designer for modeling the business process to obtain a business process model, said model including IT activities and non-IT activities, wherein states of said IT activities are monitored by outer events;
a process designer for auto-defining an activity state dependency table for the non-IT activities; and
an activity dependency manager for monitoring, by referring to said activity state dependency table, states of said non-IT activities.

9. The system according to claim 8, further comprising an activity state dependency editor, connected with the process designer, for performing at least one of modifying an activity state dependency table auto-defined by the process designer and creating an activity state dependency table.

10. The system according to claim 8, further comprising:
an event handler for receiving events associated with state changes of at least one of the IT activities and non-IT activities, and extracting the states of said at least one of the IT activities and non-IT activities;
an activity state controller, connected with the event handler, process state repositories and the activity dependency manager, for updating the process state repositories using activity states from the event handler, and invoking the activity dependency manager to determine whether state changes of said at least one of the IT activities and non-IT activities will trigger activity changes of other non-IT activities; and
the process state repositories for storing states of the activities.

11. The system according to claim 10, where said activity dependency manager further comprises:
means for determining whether the state changes of said at least one of the IT activities and non-IT activities are the only dependency that triggers the state changes of other non-IT activities;
means for, in the case where the determination result is “Yes”, sending to the event handler events which trigger the state changes of said other non-IT activities; and
means for, in the case where the determination result is “No”, recursively executing operations, and until all the dependencies are satisfied, sending to the event handler the events which trigger the state changes of said other non-IT activities.

12. The system according to claim 8, further comprising a business process renderer for rendering the activities of the business process and their states to a user.

13. The system according to claim 12, wherein the business process renderer renders a result of monitoring the business process to a user in at least one of text, icon, picture, video and audio.

14. The system according to claim 8, further comprising a timer for defining timeout and triggered action for the non-IT activities.

15. A computer program product, which contains computer executable commands on computer system readable media, wherein said commands are implemented on the computer for realizing the steps of the method for monitoring a business process, said method comprising the steps of:
modeling the business process to obtain a business process model, said model including information technology (IT) activities and non-IT activities;
auto-defining an activity state dependency table for the non-IT activities;
monitoring states of said IT activities; and
monitoring, by referring to said activity state dependency table, states of said non-IT activities.
